(19) United States
(12) Patent Application Publication
(10) Pub. No.: US 2009/0279694 A1
(43) Pub. Date: Nov. 12, 2009

(54) PRIVACY-PRESERVING SCALAR PRODUCT CALCULATION SYSTEM, PRIVACY-PRESERVING SCALAR PRODUCT CALCULATION METHOD AND CRYPTOGRAPHIC KEY SHARING SYSTEM

(76) Inventors: Kenta TAKAHASHI, Kamakura (JP); Katsuyuki OKEYA, Sagamihara (JP)

Correspondence Address: MCDERMOTT WILL & EMERY LLP, 600 13TH STREET, N.W., WASHINGTON, DC, 20005-3096, US

(21) Appl. No.: 12/393,247

(22) Filed: Feb. 26, 2009

(30) Foreign Application Priority Data
May 9, 2008 (JP) 2008-123199

(51) Int. Cl. H04L 9/28; H04L 9/08; G06F 7/58; G06F 17/16; G06F 17/14

(52) U.S. Cl. 380/28; 380/278; 708/250; 708/520; 708/400

(57) ABSTRACT

A privacy-preserving scalar product calculation system is provided. A first unit linearly transforms an n-dimensional vector Va into an n-dimensional vector based on a scalar value based on a random number Wᵢ and a random number Rⱼ to calculate a remainder by dividing each element of the linearly transformed n-dimensional vector by a random number Mᵢ, and transmits an n-dimensional converted vector X including each of the remainders as its element to the second unit, the second unit calculates an inner product value Z based on the received n-dimensional converted vector X and an n-dimensional vector Vb, and transmits the inner product value Z to the first unit, and the first unit further calculates, based on a reciprocal of the scalar value and the receive inner product value, a scalar value and which calculates a remainder by dividing the scalar value by the random number Mᵢ.

### INCORPORATION BY REFERENCE

This application claims priority based on a Japanese patent application, No. 2008-123199 filed on May 9, 2008, the entire contents of which are incorporated herein by reference.

### BACKGROUND OF THE INVENTION

The present invention relates to a privacy-preserving scalar product calculation system, a privacy-preserving scalar product calculation method, and cryptographic key sharing system capable of calculating an inner product by concealing vectors between two parties.

Research and development are actively under way for a protocol (multiparty protocol) for use in a situation wherein when data items are distributed to a plurality of parties, the respective parties cooperatively conduct various calculations for the data items while keeping the data items concealed. The multiparty protocol is considered to be applied to various fields such as the electronic poll, the electronic contract, and the privacy-protecting data mining. As a basic protocol to implement such various protocols, there exists a vector inner product calculation protocol. This is a protocol for use in a situation wherein when two parties (Alice and Bob) respectively have secret vectors Va and Vb, Alice calculates an inner product value Va*Vb while Alice and Bob are keeping the secret vectors concealed.

As a method to implement an inner product calculation protocol, there is known a method which uses Paillier cryptosystem (reference is to be made to, for example, Document 2) employing a public key for which a cryptographic function is homomorphic (reference is to be made to, for example, Document 1). This is specifically as follows.

First, Alice creates a key pair including a private key and a public key; encrypts the respective elements of own private vector Va=(a₁,a₂, . . . , aₙ) using the public key, and transmits a cipher texts E(a₁), E(a₂), . . . , E(aₙ) to Bob (E(*) is a cryptographic function). Bob receives these cipher texts and calculates using own private vectors Vb=(b₁,b₂, . . . , bₙ) by use of the homomorphic property of E(*) as below.

$$\begin{matrix}( Expression 1 ) & \\ \begin{matrix}e = {E ( {a}_{1} )}^{b 1} {E ( {a}_{2} )}^{b 2} … {E ( {a}_{n} )}^{bn} mod M \\ = E ( {a}_{1} {b}_{1} + {a}_{2} {b}_{2} + … + {a}_{n} {b}_{n} ) \\ = E ( Va * Vb )\end{matrix} & \end{matrix}$$

wherein, M is, for example, a 2048-bit integer. Bob returns e to Alice. Alice decrypts e by using the secret key to obtain the inner product value Va*Vb.

On the other hand, as secret key sharing methods (key sharing protocols) essential to cipher communication, there are known a scheme according to an RSA cryptosystem (reference is to be made to, for example, Document 3) in which safety is based on difficulty of the integer factorization problem and the Diffie-Hellman key sharing method according to the discrete logarithm problem (reference is to be made to, for example, Document 4).

Document 1: Bart Goethals, Sven Laur, Helger Lipmaa and Taneli Mielika“inen. “On Private Scalar Product Computation for Privacy-Preserving Data Mining”, The 7th Annual International Conference in Information Security and Cryptology(ICISC2004), vol. 3506 of Lecture Notes in Computer Science, pages 104-120(2004).

Document 2: Pascal Paillier. “Public-Key Cryptosystems Based on Composite Degree Residuosity Classes”, In Jacques Stern, editor, Advances in Cryptology EUROCRYPT '99, volume 1592 of Lecture Notes in Computer Science, pages 223-238, Prague, Czech Republic, 2-6 May 1999. Springer-Verlag.

Document 3: R. L. Rivest, A. Shamir, and L. Adelman, “Method for Obtaining Digital Signature and Public-key Cryptsystems”, Communications of the ACM, Vol. 21 (2), pp. 120-126. 1978.

Document 4: W. Diffie and M. E. Hellman, “New Directions in Cryptography”, IEEE Transactions on Information Theory, vol. IT-22, No. 6, pp. 644-654, November, 1976.

### SUMMARY OF THE INVENTION

The method described in Document 1, that is, the vector inner product calculation protocol employs the Paillier cryptosystem described in Document 2. However, in the conventional method, there exists a problem of the high communication cost and the high calculation cost.

Actually, according to the key length recommended in the Paillier cryptosystem, the cipher text size is 2048 bits; if the vector is n dimensional, traffic is at least 2048*n bits. Moreover, in the calculation for the encryption and decryption, a power calculation using a large integer as the modulus is required to be repeatedly conducted in proportion to n, which leads to a high calculation cost. Particularly, in a case wherein the n-vector to be processed has a large value for n or in a system in which the inner product calculation is frequently executed (such as a data mining system for a big database (DB)), there exists a problem that it is essential to reduce the calculation cost.

The present invention has been devised in consideration of the problems described above and provides a privacy-preserving scalar product calculation system, a privacy-preserving scalar product calculation method, and cryptographic key sharing system capable of reducing the communication cost and the calculation cost.

The present invention provides a privacy-preserving scalar product calculation system including a first calculation unit for concealing a first n-dimensional vector (n is a positive integer) each element of which is an integer and a second calculation unit for concealing a second n-dimensional vector each element of which is an integer, wherein the first calculation unit includes; a first communication unit capable of communicating information with the second calculation unit, a first generator for generating first, second, and third random numbers which are integers, and a converter for linearly transforming, on the basis of an m-by-m nonsingular matrix (m is a positive integer) based on the first random number and on the basis of the second random number, the first n-dimensional vector into an m-by-n matrix, calculating a remainder by dividing each element of the linearly transformed m-by-n matrix by the third random number, and transmitting an m-by-n transformed matrix each element of which is the remainder by the first communication unit; the second calculation unit includes; a second communication unit capable of communicating information with the first calculation unit, and a calculating section for calculating an m-dimensional vector on the basis of the m-by-n matrix transformed matrix received by the second communication unit and the second n-dimensional vector and transmitting the m-dimensional vector by the second communication unit; and the first calculation unit further includes an inverse converter for calculating an m-dimensional vector on the basis of an inverse matrix obtained from the m-by-m nonsingular matrix using the third random number as a modulus and the m-dimensional vector received by the first communication unit, and calculating a remainder by dividing predetermined elements of the m-dimensional vector by the third random number.

Additionally, the present invention provides a privacy-preserving scalar product calculation method for use with a system including a first calculation unit for concealing a first n-dimensional vector (n is a positive integer) each element of which is an integer and a second calculation unit for concealing a second n-dimensional vector each element of which,is an integer, wherein the first calculation unit includes a first communication unit capable of communicating information with the second calculation unit, and the second calculation unit includes a second communication unit capable of communicating information with the first calculation unit, the method including a first generating step of generating first, second, and third random numbers which are integers by the first calculation unit; a converting step of linearly transforming by the first calculation unit, on the basis of an m-by-m nonsingular matrix (m is a positive integer) based on the first random number and on the basis of the second random number, the first n-dimensional vector into an m-by-n matrix, calculating a remainder by dividing each element of the linearly transformed m-by-n matrix by the third random number, and transmitting an m-by-n transformed matrix each element of which is the remainder by the first communication unit; a calculating step of calculating by the second calculation unit an m-dimensional vector on the basis of the m-by-n matrix transformed matrix received by the second communication unit and the second n-dimensional vector and transmitting the m-dimensional vector by the second communication unit; and an inversely converting step of calculating by the first calculation unit an m-dimensional vector on the basis of an inverse matrix obtained from the m-by-m nonsingular matrix using the third random number as a modulus and the m-dimensional vector received by the first communication unit, and calculating a remainder by dividing predetermined elements of the m-dimensional vector by the third random number.

In accordance with the disclosed system, on the basis of an m-by-m nonsingular matrix (m is a positive integer) based on the first random number and on the basis of the second random number, the first n-dimensional vector is transformed into an m-by-n matrix and each element of the linearly transformed m-by-n matrix is divided by the third random number to calculate a remainder by the first calculation unit, and an m-by-n transformed matrix each element of which is the remainder is transmitted by the first communication unit. Also, an m-dimensional vector is calculated by the second calculation unit on the basis of the m-by-n matrix transformed matrix received by the second communication unit and the second n-dimensional vector and the m-dimensional vector is transmitted by the second communication unit. Further, an m-dimensional vector is calculated by the first calculation unit on the basis of an inverse matrix obtained from the m-by-m nonsingular matrix using the third random number as a modulus and the m-dimensional vector received by the first communication unit, and predetermined elements of the m-dimensional vector are divided by the third random number to calculate a remainder. Therefore, assuming that it is possible to secure safety similar to that of the prior art, in a situation wherein the first and third random numbers are, for example, 100-bit integers, the traffic is about 100*n bits for both of the transmission and the reception; the calculation in the first calculation unit is a multiplication using the third random number as the modulus, and that in the second calculation unit is n multiplications and n additions.

In accordance with the teaching herein, assuming that it is possible to secure safety similar to that of the prior art, in a situation wherein, for example, m=1 and the first and third random numbers are 100-bit integers, the traffic from the first calculation unit to the second calculation unit is about 100*n bits and the traffic from the second calculation unit to the first calculation unit is about 100 bits; the calculation in the first calculation unit is a multiplication using the third random number as the modulus, and that in the second calculation unit is n multiplications and n additions. Therefore, the traffic of at least 2048*n bits for both of the transmission and the reception and the power calculation using a 2048-bit number as the modulus of the prior art are not required, and it is possible to employ a modulus less than that of the prior art; since the multiplication and the addition are in the cost one several-hundredths of the power calculation, the communication cost and the calculation cost can be reduced when compared with the prior art.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a general configuration diagram exemplifying a functional configuration of a privacy-preserving scalar product calculation system.

FIG. 2 exemplifies a hardware configuration of first and second calculation units shown in FIG. 1.

FIG. 3 is a flowchart exemplifying operation of the privacy-preserving scalar product calculation system.

FIG. 4 is a flowchart exemplifying operation of the privacy-preserving scalar product calculation system in accordance with a second embodying mode.

FIG. 5 is a general configuration diagram exemplifying a functional configuration of a cryptographic key sharing system.

### DETAILED DESCRIPTION OF THE EMBODIMENTS

Next, an embodiment of the present invention will be described in detail by referring to drawings.

### [First Embodying Mode]

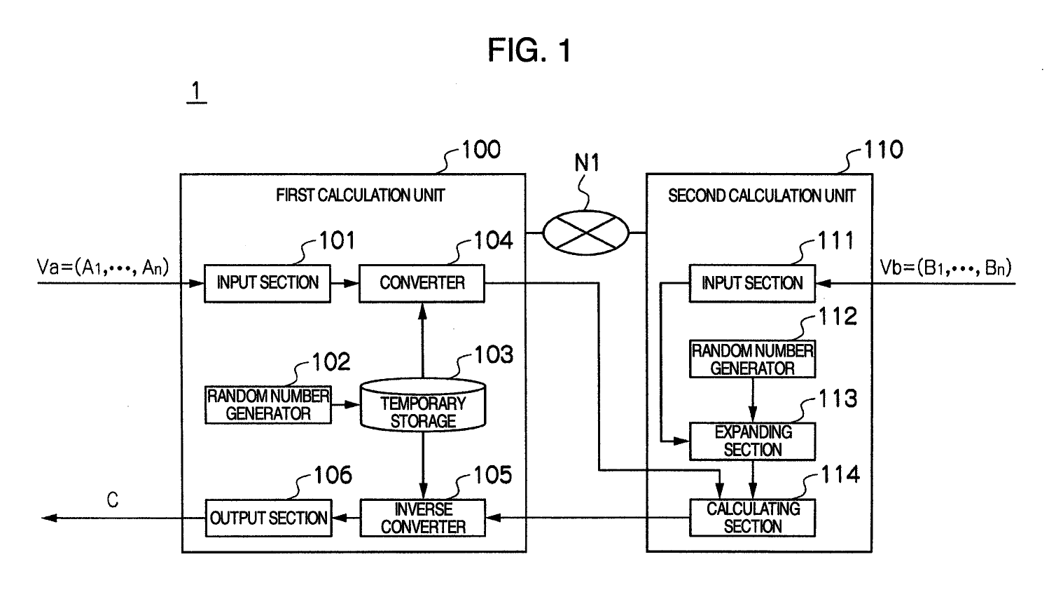

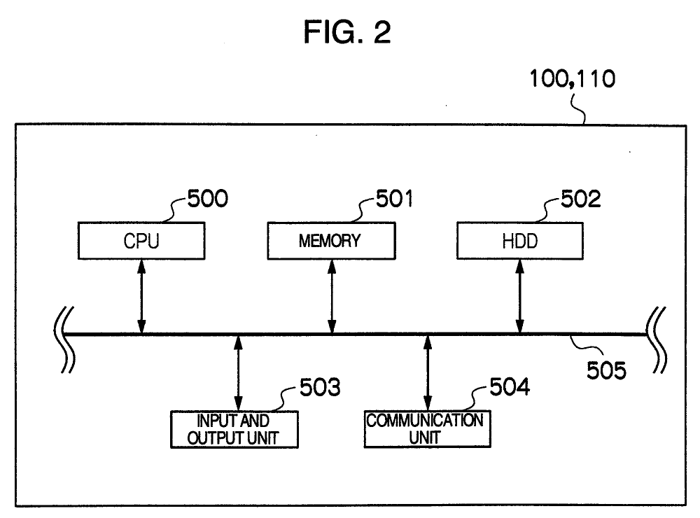

FIGS. 1 to 3 show a first embodying mode of the present invention. First, referring to FIGS. 1 and 2, description will be given of structure of a privacy-preserving scalar product calculation system. FIG. 1 is a general configuration diagram to explain a functional configuration of a privacy-preserving scalar product calculation system.

As FIG. 1 shows, the privacy-preserving scalar product calculation system 1 includes a first calculation unit 100 for concealing an n-dimensional vector Va=(A₁,A₂, . . . , Aₙ) (n is a positive integer) in which each element is an integer and a second calculation unit 110 for concealing an n-dimensional vector Vb=(B₁,B₂, . . . , Bₙ) in which each element is an integer; the first and second calculation units 100 and 110 to which a positive integer, i.e., a predetermined number Q is set communicate with each other by concealing the n-dimensional vectors Va and Vb possessed by the respective units such that the first calculation unit 100 calculates a remainder C using formula 1.

$$\begin{matrix}( Expression 2 ) & \\ \begin{matrix}C = Va * Vb mod Q \\ = {A}_{1} {B}_{1} + {A}_{2} {B}_{2} + … + {A}_{n} {B}_{n} mod Q\end{matrix} & ( 1 )\end{matrix}$$

The first and second calculation units 100 and 110 are coupled via a network N1 with each other. The first calculation unit 100 includes an input section 101, a random number generator 102, a temporary storage 103, a converter 104, an inverse converter 105, and an output unit 106.

To the input section 101, the above n-dimensional vector Va is inputted. The random number generator 102 generates a random number including an integer, which will be described later. The temporary storage 103 temporarily stores the generated random number. The converter 104 converts, by use of the generated random number, each element value of the n-dimensional vector Va to produce a converted vector X and sends the vector X to the second calculation unit 110. The inverse converter 105 receives an inner product value Z, which will be described later, transmitted from the second calculation unit 110 and calculates a remainder C by using the generated random number and the received inner product value Z. The output section 106 outputs the calculated remainder C.

The second calculation unit 110 includes an input section 111, a random number generator 112, an expanding section 113, and a calculating section 114.

To the input section 111, the above n-dimensional vector Vb is inputted. The random number generator 102 generates a random number including an integer, which will be described later. The expanding section 113 generates an n-dimensional expanded vector Y, which will be described later. The calculating section 104 receives the n-dimensional converted vector X transmitted from the first calculation unit 100, calculates an inner product value Z between the received n-dimensional converted vector X and the n-dimensional expanded vector Y, and sends the inner product value Z to the first calculation unit 100.

In the present embodying mode, the n-dimensional vector Va is inputted to the input section 101 of the first calculation unit 100 and the n-dimensional vector Vb is inputted to the input section 111 of the second calculation unit 110; however, this is not limitative, but it is also possible that the first calculation unit 100 generates the n-dimensional vector Va and the second calculation unit 110 generates the n-dimensional vector Vb.

FIG. 2 is a general configuration diagram to explain a hardware configuration of the first and second calculation units shown in FIG. 1.

As shown in FIG. 2, each of the first and second calculation units 100 and 110 includes a CPU 500, a memory 501, an HDD 502, an input and output unit 503, and a communication unit 504; the CPU 500, the memory 501, the HDD 502, the input and output unit 503, and the communication unit 504 are coupled via an internal bus 505 with each other.

The CPU 500 corresponds to the random number generator 102, the converter 104, and the inverse converter 105, which are shown in FIG. 1, in the first calculation unit 100, and corresponds to the random number generator 112, the expanding section 113, and the calculating section 114 in the second calculation unit 110. The memory 501 or the HDD 502 corresponds to the temporary storage 103 shown in FIG. 1. The input and output unit 503 corresponds to the input section 101 and the output section 106, which are shown in FIG. 1, in the first calculation unit 100, and corresponds to the input section 111 in the second calculation unit 110. The communication calculation unit 504 enables information communication between the first and second calculation units 100 and 110, and is employed for the converter 104 and the inverse converter 105, which are shown in FIG. 1, in the first calculation unit 100, and is employed for the computing section 114 in the second calculation unit 110. In this regard, The memory 501 or the HDD 502 of the first calculation unit 100 stores the predetermined numbers Q and n as system parameters described above and the positive-integer predetermined numbers R, S, and p as security parameters, which will be described later. Also, the memory 501 or the HDD 502 of the second calculation unit 110 stores the predetermined numbers Q and n as system parameters described above and the positive-integer predetermined number S as a security parameter, which will be described later.

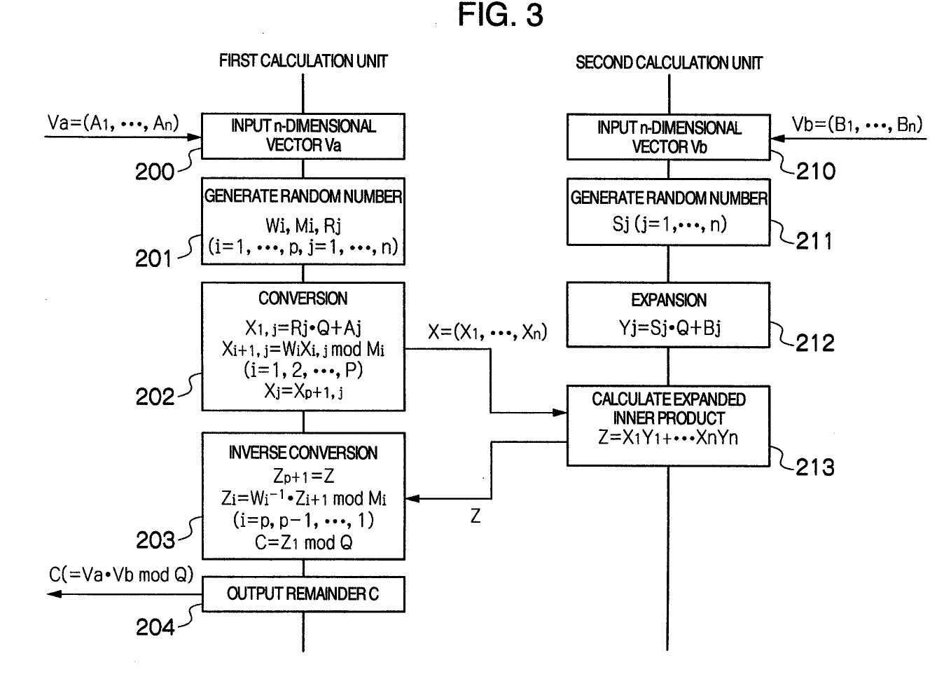

Next, referring to FIG. 3, description will be given of operation of the privacy-preserving scalar product calculation system. FIG. 3 is a flowchart to explain the operation of the privacy-preserving scalar product calculation system in accordance with the present invention.

As FIG. 3 shows, the n-dimensional vector Va is first inputted to the input section 101 of the first calculation unit 100 (S200).

Next, the random number generator 102 generates a random number Rⱼ(j=1, 2, . . . , n), a random number Mᵢ(i=1, 2, . . . , p), and a random number Wᵢ(i=1, 2, . . . , p) such that the predetermined numbers Q and n stored as system parameters and the predetermined numbers R, S, and p stored as security parameters satisfy the following formulas 2 to 6, and then stores the random numbers in the temporary storage (S201).

(Expression 3)

R₁,R₂, . . . ,Rₙ<R (2)

M₁>nRSQ² (3)

Mᵢ>nRSQ²Mᵢ₋₁(i=2,3, . . . , p) (4)

Wᵢ<Mᵢ (5)

GCD(Wᵢ,Mᵢ)=1 (6)

In the formulas, GCD(a,b) represents the greatest common divisor of a and b; to satisfy formula 6, random numbers Mᵢ and Mᵢ are randomly generated to calculate GCD(Mᵢ,Mᵢ); if this is other than one, random numbers Mᵢ and Mᵢ are again generated.

Subsequently, the converter 104 calculates the following formulas 7 to 9 for each element Aⱼ(j=1, 2, . . . , n) of the n-dimensional vector Va to attain an n-dimensional converted vector X=(X₁,X₂, . . . , Xₙ) and transmits the vector X by the communication unit 504 to the second calculation unit 110 (S202). As above, by use of the random numbers Rⱼ, Mᵢ and Wᵢ generated through the processing in S201, each element Aⱼ of the n-dimensional vector Va is expanded (one-dimensional transformation) using the random number Rⱼ, the resultant element is then linearly transformed using the random number Wᵢ, and the remainder is calculated using the random number Mᵢ; hence, the second calculation unit 110 cannot infer the n-dimensional vector Va from the transmitted n-dimensional converted vector X, that is, the n-dimensional vector Va is concealed from the second calculation unit 110.

(Expression 4)

X_{i,j}=RⱼQ+Aⱼ (7)

X_{i+1,j}=WⱼX_{i,j} mod Mᵢ(repeatedly calculate for i=1, 2, . . . , p) (8)

Xⱼ=X_{p+1,j} (9)

In the present embodying mode, in order that safety is enhanced by making it difficult to calculate or to predict the n-dimensional vector Va from the n-dimensional vector X, each element Aⱼ of the n-dimensional vector Va is expanded by use of formula 7, but it is not limitative; in a situation wherein high safety is not required or safety can be enhanced in any other method, it is not necessary to expand each element Aⱼ of the n-dimensional vector Va. Also, for a similar reason, the remainder is p times calculated using formula 8, but the predetermined number p may be one. In this case, in the processing of S201, the random number generator 102 does not generate the random number Rⱼ, but generates only the random numbers M and W; in the processing of S202, the converter 104 calculates the following formula 8′ to obtain the n-dimensional converted vector X=(X₁,X₂, . . . , Xₙ). As above, by use of the random numbers M and W generated through the processing in S201, each element Aⱼ of the n-dimensional vector Va is linearly transformed using the random number W and the remainder is calculated using the random number M; therefore, even if each element Aⱼ is not expanded (one-dimensional transformation), the second calculation unit 110 cannot infer the n-dimensional vector Va from the transmitted n-dimensional converted vector X, that is, the n-dimensional vector Va is concealed from the second calculation unit 110.

(Expression 5)

Xⱼ=WAⱼ mod M(j=1,2, . . . , n) (8)′

On the other hand, the n-dimensional vector Vb is inputted to the input section 111 of the second calculation unit 110 (S210).

Subsequently, the random number generator 112 generates a random number Sⱼ (j=1,2, . . . , n) to satisfy the following formula 10 (S211).

(Expression 6)

S₁, S₂, . . . , Sₙ<S (10)

Next, the expanding section 113 conducts a calculation of the following formula 11 for each element Bⱼ(J=1,2, . . . ,n) of the n-dimensional vector Vb to obtain an n-dimensional expanded vector Y=(Y1,Y2, . . . ,Yn) (S212).

(Expression 7)

Yⱼ=SⱼQ+Bⱼ (11)

In this connection, the processing of S210 to S212 may be executed before, after, or in concurrence with the processing of S200 to S202 described above.

Next, the calculating section 114 receives the converted vector X by the communication unit 504 from the first calculation unit 100, calculates the following formula 12 to transmit the inner product value Z by the communication unit 504 to the first calculation unit 100 (S213). In this way, by using the random number Sⱼ generated by the processing of S211, each element Bⱼ of the n-dimensional vector Vb is expanded (one-dimensional transformation) using the random number Sⱼ to calculate the inner product value Z between the expanded result and the n-dimensional converted vector X; since the calculated inner product value Z is a scalar value (one-dimensional vector), the first calculation unit 100 cannot infer the n-dimensional vector Vb from the transmitted inner product value Z, and the n-dimensional vector Vb is concealed from the first calculation unit 100.

(Expression 8)

Z=X₁B₁+X₂B₂+ . . . +XₙBₙ (12)

In the present embodying mode, for a similar reason as described above, each element Bⱼ of the n-dimensional vector Vb is expanded using formula 11, but it is not limitative; each element Bⱼ of the n-dimensional vector Vb need not to be necessarily expanded. In this case, the processing of S211 and S212 is not executed; in the processing of S213 after the processing of S210, the calculating section 114 obtains the inner product value Z by calculating the following formula 12′. In this way, the inner product value Z is calculated between the n-dimensional converted vector X and the n-dimensional vector Vb; the calculated inner product value Z is a scalar value (one-dimensional vector); hence, even if each element Bⱼ is not expanded (one-dimensional transformation), the first calculation unit 100 cannot infer the n-dimensional vector Vb from the transmitted inner product Z, and the n-dimensional vector Vb is concealed from the second calculation unit 110.

(Expression 9)

Z=X₁B₁+X₂B₂+ . . . +XₙBₙ (12)

Subsequently, the inverse converter 105 of the first calculation unit 100 receives by the communication unit 504 the inner product value Z from the second calculation unit 110, calculates the following formulas 13 to 15 using the random numbers Mᵢ and Wᵢ stored in the temporary storage 103 to obtain the remainder C (S203). Therefore, assuming that it is possible to secure safety similar to that of the prior art, in a situation wherein the random numbers Mᵢ and Wᵢ are, for example, 100-bit integers, the traffic is about 100*n bits for both of the transmission and the reception; the calculation in the first calculation unit 100 is a multiplication using the random number Mᵢ as the modulus, and that in the second calculation unit 110 is n multiplications and n additions. Also, in this way, the remainder C calculated using formulas 2 to 15 while the first and second calculation units 100 and 110 are keeping secret the n-dimensional vectors Va and Vb respectively possessed by themselves is equal to the remainder C calculated using formula 1.

(Expression 10)

Zₚ₊₁=Z (13)

Zᵢ=Wᵢ⁻¹Zᵢ₊₁ mod Mᵢ (repeatedly calculate for i=p,p−1, . . . ,1) (14)

C=Z₁ mod Q (15)

In this situation, for the maximum value N in each element Aⱼ (J=1,2, . . . ,n) of the n-dimensional vector Va and each element Bⱼ (J=1,2, . . . ,n) of the n-dimensional vector Vb, if Q is set to satisfy the following formula 16, the remainder C is equal to the inner product value Va*Vb of the n-dimensional vectors Va and Vb. As a result, the first and second calculation units 100 and 110 can calculate the correct inner product value Va*Vb by keeping secret the n-dimensional vectors Va and Vb respectively possessed by themselves.

(Expression 11)

Q>nN² (16)

In the present embodying mode, for a similar reason, the remainder is p times calculated using formula 14, but the predetermined number p may be one. Also, for a similar reason, the remainder of the modulus Q is calculated using formula 15, it is not limitative, but the remainder of the modulus Q need not to be necessarily calculated. In this case, in the processing of S203, the inverse converter 105 obtains the remainder C by calculating the following formula 14′. As above, the remainder C calculated using formulas 8′, 12′, and 14′ while the first and second calculation units 100 and 110 are keeping secret the n-dimensional vectors Va and Vb respectively possessed by themselves is equal to the inner product value Va*Vb of the n-dimensional vectors Va and Vb; hence, it is possible to calculate the correct inner product value Va*Vb.

(Expression 12)

C=W⁻¹Z mod M (14)′

Finally, the output section 106 outputs the remainder C (S204).

As above, according to the present embodying mode, the first calculation unit 100 linearly transforms the n-dimensional vector Va into n scalar values (one-by-n matrix) on the basis of the scalar value (one-by-one nonsingular matrix) based on the random number Wᵢ (i=1, 2, . . . , p) as well as the random number Rⱼ (j=1, 2, . . . , n) to calculate a remainder by dividing the linearly transformed result by the random number Mᵢ (i=1, 2, . . . , p), and the n-dimensional converted vector X (one-by-n converted vector) including each of the remainders as its element is transmitted by the communication unit 504. In addition, the second calculation unit 110 calculates the inner product value Z (one-dimensional vector) based on the n-dimensional converted vector X (one-by-n transformed matrix) received by the communication unit 504 and the n-dimensional vector Vb; and the inner product value Z (one-dimensional vector) is transmitted by the communication unit 504. Moreover, the first calculation unit 100 calculates the scalar value (one-dimensional vector) on the basis of the reciprocal number (inverse matrix) using the random number Mᵢ (i=1, 2, . . . , p) of the scalar value (one-by-one nonsingular matrix) as the modulus and the inner product value Z (one-dimensional vector) received by the communication unit 504 to calculate the remainder C by dividing the scalar value (one-dimensional vector) by the random number Mᵢ (i=1, 2, . . . , p). Therefore, assuming that it is possible to secure safety similar to that of the prior art, in a situation wherein the random numbers Mᵢ and Wᵢ are, for example, 100-bit integers, the traffic is about 100*n bits for both of the transmission and the reception; the calculation in the first calculation unit 100 is a multiplication using the random number Mᵢ as the modulus, and that in the second calculation unit 110 is n multiplications and n additions. As a result, the traffic equal to or more than 2048*n bits for both of the transmission and the reception and the power calculation using a 2048-bit number employed in the prior art are not required; since the calculation can be conducted by using as the modulus the random number Mi smaller than that of the prior art and by use of the multiplication and the addition which are, in the calculation speed, about one several hundredths of the power calculation, it is possible to reduce the communication cost and the calculation cost when compared with the prior art.

In addition, by use of the random numbers Rⱼ, Mᵢ, and Wᵢ generated through the processing of S201, each element Aⱼ of the n-dimensional vector Va is expanded (one-dimensional transformation) using the random number Rⱼ and the expanded result is thereafter linearly transformed using the random number Wᵢ to calculate the remainder by use of the random number Mᵢ; hence, the second calculation unit 110 cannot infer the n-dimensional vector Va from the n-dimensional converted vector X, and the n-dimensional vector Va is concealed from the second calculation unit 110. By using the random number Sⱼ generated through the processing of S211, each element Bⱼ of the n-dimensional vector Vb is expanded (one-dimensional transformation) using the random number Sⱼ, and then the inner product value Z between the expanded result and the n-dimensional converted vector X is calculated; since the calculated inner product value Z is a scalar value (one-dimensional vector), the first calculation unit 100 cannot infer the n-dimensional vector Vb from the transmitted inner product value Z, and the n-dimensional vector Vb is concealed from the first calculation unit 100. As a result, the remainder C calculated using formulas 2 to 15 while the first and second calculation units 100 and 110 are keeping secret the n-dimensional vectors Va and Vb respectively possessed by themselves is equal to the remainder C calculated using formula 1.

Additionally, by using the random numbers M and W generated through the processing of S201, each element Aⱼ of the n-dimensional vector Va is linearly transformed using the random number W to calculate the remainder using the random number M; hence, even if each element Aⱼ is not expanded (one-dimensional transformation), the second calculation unit 110 cannot infer the n-dimensional vector Va from the transmitted n-dimensional converted vector X, and the n-dimensional vector Va is concealed from the second calculation unit 110. The inner product value Z between the n-dimensional converted vector X and the n-dimensional vector Vb is calculated; the calculated inner product value Z is a scalar value (one-dimensional vector); hence, even if each element Bⱼ is not expanded (one-dimensional transformation), the first calculation unit 100 cannot infer the n-dimensional vector Vb from the transmitted inner product value Z, and the n-dimensional vector Vb is concealed from the first calculation unit 100. As a result, the remainder C calculated using formulas 8′, 12′, and 14′ while the first and second calculation units 100 and 110 are keeping secret the n-dimensional vectors Va and Vb respectively possessed by themselves is equal to the inner product value Va*Vb of the n-dimensional vectors Va and Vb; hence, it is possible to calculate the correct inner product value Va*Vb.

Furthermore, for the maximum value N in each element Aⱼ (j=1,2, . . . ,n) of the n-dimensional vector Va and each element Bⱼ (j=1,2, . . . ,n) of the n-dimensional vector Vb, Q is set to satisfy the following formula 16; hence, the remainder C is equal to the inner product value Va*Vb of the n-dimensional vectors Va and Vb. As a result, the first and second calculation units 100 and 110 can calculate the correct inner product value Va*Vb by keeping secret the n-dimensional vectors Va and Vb respectively possessed by themselves.

### [Second Embodying Mode]

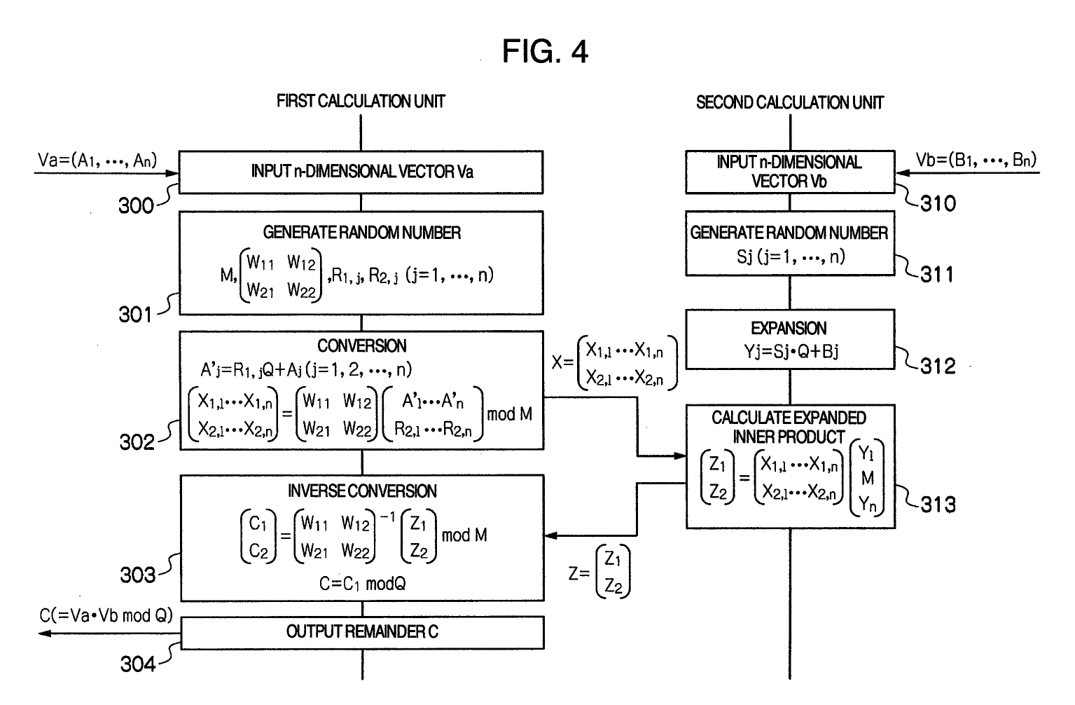

FIG. 4 shows a second embodying mode of the present invention, and this diagram is a flowchart to explain operation of a privacy-preserving scalar product calculation system in accordance with the second embodying mode.

The second embodying mode differs from the first second embodying mode in that there is employed, in place of an operation to conduct the one-dimensional transformation for the n-dimensional vector Va to produce the n-dimensional converted vector X, an operation to conduct a two-dimensional transformation for the n-dimensional vector Va to produce a two-by-n transformed matrix. In this connection, the functional configuration and the hardware configuration of the privacy-preserving scalar product calculation system according to the second embodying mode are similar to those of FIGS. 1 and 2 shown for the first embodying mode; hence, illustration and description thereof will be avoided.

First, the n-dimensional vector Va is inputted to the input section 101 of the first calculation unit 100 (step S300).

Next, the random number generator 102 generates random numbers R_{1,j} (j=1,2, . . . ,n) and R_{2,j} (j=1,2, . . . ,n), a random number M, and random numbers W₁₁, W₁₂, W₂₁, and W₂₂ (S301).

(Expression 13)

R_{1,j},R_{1,j}, . . . ,R_{1,n}R (20)

M>nRSQ² (21)

R_{2,j}R_{2,j}, . . . ,R_{2,n}M (22)

W₁₁,W₁₂,W₂₁,W₂₂<M (23)

GCD(W₁₁W₂₂−W₁₂W₂₁,M)=1 (24)

In the situation, to satisfy the condition of formula 24, M, W₁₁, W₁₂, W₂₁, and W₂₂ are first randomly generated, and GCD(W₁₁ W₂₂−W₁₂ W₂₁,M) is calculated using Euclidean algorithm; if this is other than one, W₁₁, W₁₂, W₂₁, and W₂₂ are again calculated.

Subsequently, the converter 104 calculates the following formulas 25 and 26 for each element Aⱼ (j=1, 2, . . . , n) of the n-dimensional vector Va to attain a 2-by-n transformed matrix X and transmits the matrix X by the communication unit 504 to the second calculation unit 110 (S302). As above, by use of the random numbers R_{1,j}, R_{2,j}, and M as well as W₁₁, W₁₂, W₂₁, and W₂₂ generated through the processing of S301, each element Aⱼ of the n-dimensional vector Va is expanded (one-dimensional transformation) using the random number R_{1,j}, and further expanded to two-demention using the random number R_{2,j}, the expanded result is then linearly transformed using a 2-by-2 matrix based on the random numbers W₁₁, W₁₂, W₂₁, and W₂₂, and the remainder is calculated using the random number M; hence, the second calculation unit 110 cannot infer the n-dimensional vector Va from the 2-by-n transformed matrix X, that is, the n-dimensional vector Va is concealed from the second calculation unit 110.

$$\begin{matrix}( Expression 14 ) & \\ {A}_{j}^{′} = {R}_{1 , j} \cdot Q + {A}_{j} \\ ( j = 1 , 2 , … n ) & ( 25 ) \\ X = ( \begin{matrix}{X}_{1 , 1} … {X}_{1 , n} \\ {X}_{2 , 1} … {X}_{2 , n}\end{matrix} ) = ( \begin{matrix}{W}_{11} & {W}_{12} \\ {W}_{21} & {W}_{22}\end{matrix} ) ( \begin{matrix}{A}_{1}^{′} … {A}_{n}^{′} \\ {R}_{2 , 1} … {R}_{2 , n}\end{matrix} ) mod M & ( 26 )\end{matrix}$$

In the present embodying mode, for a similar reason as described above, each element Aⱼ of the n-dimensional vector Va is expanded using formula 25, but as in the first embodying mode, each element Aⱼ of the n-dimensional vector Va need not to be necessarily expanded. In this case, in the processing of S301, the random number generator 102 does not generate the random number R_{1,j}, but generates only the random numbers R_{2,j} and M as well as W₁₁, W₁₂, W₂₁, and W₂₂; in the processing of S302, the converter 104 calculates the following formula 26′ to obtain the 2-by-n transformed matrix X. As above, by use of the random numbers R_{2,j} and M as well as W₁₁, W₁₂, W₂₁, and W₂₂ generated through the processing of S301, each element Aⱼ of the n-dimensional vector Va is expanded into a two-dimensional format using the random number R_{2,j} and is then linearly transformed using a two-by-two matrix based on the random numbers W₁₁, W₁₂, W₂₁, and W₂₂, and the remainder is calculated using the random number M; therefore, even if each element Aⱼ is not expanded (one-dimensional transformation), the second calculation unit 110 cannot infer the n-dimensional vector Va from the transmitted two-by-n transformed matrix X, that is, the n-dimensional vector Va is concealed from the second calculation unit 110.

$$\begin{matrix}( Expression 15 ) & \\ X = ( \begin{matrix}{X}_{1 , 1} … {X}_{1 , n} \\ {X}_{2 , 1} … {X}_{2 , n}\end{matrix} ) = ( \begin{matrix}{W}_{11} & {W}_{12} \\ {W}_{21} & {W}_{22}\end{matrix} ) ( \begin{matrix}{A}_{1}^{′} … {A}_{n}^{′} \\ {R}_{2 , 1} … {R}_{2 , n}\end{matrix} ) mod M & {( 26 )}^{′}\end{matrix}$$

On the other hand, the n-dimensional vector Vb is inputted to the input section 111 of the second calculation unit 110 (S310).

Next, the random number generator 112 generates the random number Sⱼ (j=1,2, . . . ,n) to satisfy expression 10 described above (S311).

Subsequently, the expanding section 113 calculates formula 11 described above for each element Bⱼ (j=1,2, . . . ,n) of the n-dimensional vector Vb to attain an n-dimensional converted vector Y=(Y₁,Y₂, . . . ,Yₙ) (S312).

Incidentally, the processing of S310 to S312 may be executed before, after, or in concurrence with the processing of S300 to S302.

Next, the calculating section 114 receives the two-by-n transformed matrix X from the first calculation unit 100, calculates the following formula 27, and sends a two-dimensional vector Z=(Z₁, Z₂) by the communication unit 504 to the first calculation unit 100 (S313). In this way, by use of the random number Sⱼ generated by the processing of S311, each element Bⱼ of the n-dimensional vector Vb is expanded (one-dimensional transformation) using the random number Sⱼ to calculate the two-dimensional vector Z which is a product between the expanded result and the two-by-n transformed matrix X; hence, the first calculation unit 100 cannot infer the n-dimensional vector Vb from the transmitted two-dimensional vector Z, that is, the n-dimensional vector Va is concealed from the first calculation unit 100.

$$\begin{matrix}( Expression 16 ) & \\ ( \begin{matrix}{Z}_{1} \\ {Z}_{2}\end{matrix} ) = ( \begin{matrix}{X}_{1 , 1 } … {X}_{1 , n} \\ {X}_{2 , 1} … {X}_{2 , n}\end{matrix} ) ( \begin{matrix}{Y}_{1} \\ ⋮ \\ {Y}_{n}\end{matrix} ) & ( 27 )\end{matrix}$$

In the present embodying mode, for a similar reason as described above, each element Bⱼ of the n-dimensional vector Vb is expanded using formula 11, but as in the first embodying mode, each element Bⱼ of the n-dimensional vector Vb need not to be necessarily expanded. In this case, the processing of S311 and S312 is not executed; in the processing of S213 after the processing of S310, the calculating section 114 obtains the two-dimensional vector Z by calculating the following formula 27′. In this way, the two-dimensional vector Z which is a product between the 2-by-n transformed matrix X and the n-dimensional vector Vb is calculated; hence, even if each element Bⱼ is not expanded (one-dimensional transformation), the first calculation unit 100 cannot infer the n-dimensional vector Vb from the transmitted two-dimensional vector Z, that is, the n-dimensional vector Vb is concealed from the first calculation unit 100.

$$\begin{matrix}( Expression 17 ) & \\ ( \begin{matrix}{Z}_{1} \\ {Z}_{2}\end{matrix} ) = ( \begin{matrix}{X}_{1 , 1 } … {X}_{1 , n} \\ {X}_{2 , 1} … {X}_{2 , n}\end{matrix} ) ( \begin{matrix}{B}_{1} \\ ⋮ \\ {B}_{n}\end{matrix} ) , & ( 27 )\end{matrix}$$

Next, the inverse converter 105 of the first calculation unit 100 receives by the communication unit 504 the two-dimensional vector Z from the second calculation unit 110 and calculates the following formulas 28 and 29 using the random numbers M and W₁₁, W₁₂, W₂₁, and W₂₂ stored in the temporary storage 103 to calculate the remainder C (S303). Therefore, assuming that it is possible to secure safety similar to that of the prior art, in a situation wherein the random numbers Mᵢ and Wᵢ are, for example, 100-bit integers, the traffic is about 2*100*n bits for both of the transmission and the reception; the calculation in each of the first and second calculation units 100 and 110 is about several times of n multiplications and n additions. Also, in this way, the remainder C calculated using formulas 20 to 29 while the first and second calculation units 100 and 110 are keeping secret the n-dimensional vectors Va and Vb respectively possessed by themselves is equal to the remainder C calculated using formula 1.

$$\begin{matrix}( Expression 18 ) & \\ ( \begin{matrix}{C}_{1} \\ {C}_{2}\end{matrix} ) = {( \begin{matrix}{W}_{11 } … {X}_{12} \\ {W}_{21} … {X}_{22}\end{matrix} )}^{- 1} ( \begin{matrix}{Z}_{1} \\ ⋮ \\ {Z}_{2}\end{matrix} ) mod M & ( 28 ) \\ C = {C}_{1} mod Q & ( 29 )\end{matrix}$$

In this situation, as in the first embodying mode, if Q is set to satisfy the formula 16 described above, the remainder C is equal to the inner product value Va*Vb. As a result, the first and second calculation units 100 and 110 can calculate the correct inner product value Va*Vb by keeping secret the n-dimensional vectors Va and Vb respectively possessed by themselves.

In the present embodying mode, for a similar reason described above, the remainder of the modulus Q is calculated using formula 29, but as in the first embodying mode, the remainder of the modulus Q need not to be necessarily calculated. In this case, in the processing of S303, the inverse converter 105 obtains the remainder C by calculating formula 28 and the following formula 29′. As above, the remainder C calculated using formulas 26′, 27′, 28′, and 29′ while the first and second calculation units 100 and 110 are keeping secret the n-dimensional vectors Va and Vb respectively possessed by themselves is equal to the inner product value Va*Vb of the n-dimensional vectors Va and Vb; hence, it is possible to calculate the correct inner product value Va*Vb.

(Expression 19)

C=C (29)′

Finally, the output section 106 outputs the remainder C (S304).

As above, according to the present embodying mode, even if the n-dimensional vector Va is transformed through a two-dimensional transformation into a two-by-n transformed matrix, there is attained an advantage similar to that of the first embodying mode, and safety can be further increased by slightly sacrificing the calculation cost.

Additionally, even if the n-dimensional vector Va is transformed through an m-dimensional transformation into an m-by-n transformed matrix (m is an integer equal to or more than three), there is attained an advantage similar to that of the present embodying mode.

It has been confirmed that the methods described in Documents 3 and 4 described above, which are cryptographic key sharing protocols for cipher communication in the prior art, are broken by a quantum computer. This is because the integer factorization problem and the discrete logarithm problem which are difficult for the computers at present can be easily solved by the quantum computer. Hence, in order that safety is secured even if the quantum computer is implemented in future, a new cryptographic key sharing system independent of the integer factorization problem and the discrete logarithm problem is required.

The cryptographic key sharing system according to the third embodying mode of the present invention has been devised in consideration of the above problem and provides a cryptographic key sharing system resistive also against the quantum computer.

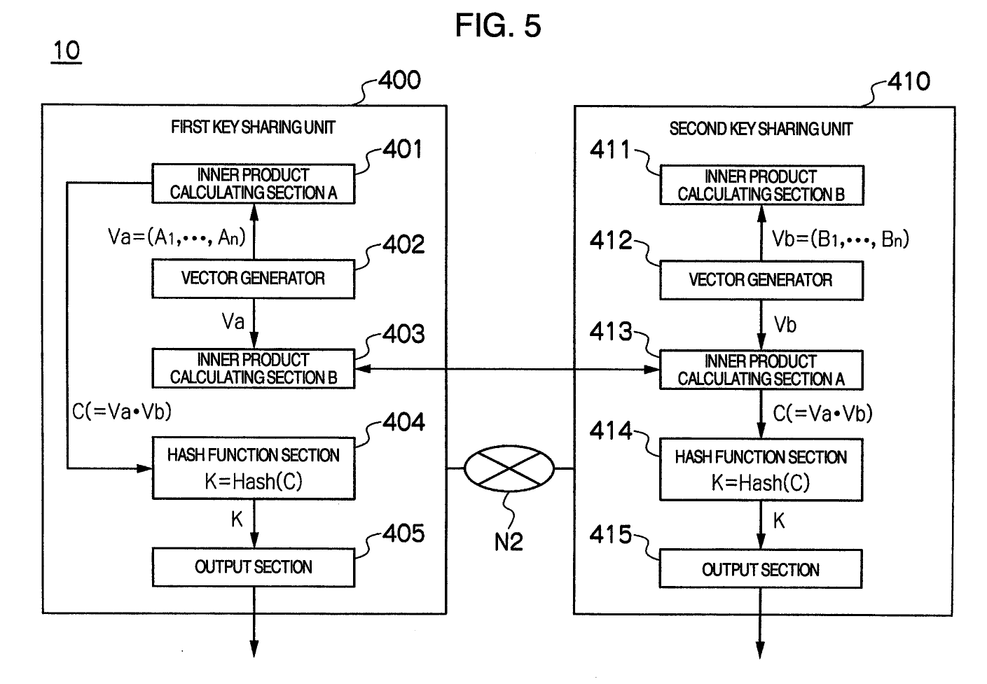

FIG. 5 shows the third embodying mode of the present invention; this diagram is a general configuration diagram to explain the functional configuration of the cryptographic key sharing system. In this regard, the hardware configuration of the cryptographic key sharing system is similar to that of FIG. 2 shown for the first embodying mode; hence, illustration and description thereof will be avoided.

As shown in FIG. 5, the cryptographic key sharing system 10 includes a first key sharing unit 400 and a second key sharing unit 410; the first and second key sharing units 400 and 410 are coupled via a network N2 with each other.

The first key sharing unit 400 includes an inner product calculating section A 401, a vector generator 402, an inner product calculating section B 403, a hash function section 404, and an output section 405. The inner product calculating section A 401 has a function equal to that of the first calculation unit 100 of the first or second embodying mode, that is, it includes an input section 101, a random number generator 102, a temporary storage 103, a converter 104, an inverse converter 105, and an output section 106. The inner product calculating section B 403 has a function equal to that of the second calculation unit 110 of the first or second embodying mode, that is, it includes an input section 111, a random number generator 112, an expanding section 113, and a calculating section 114. The vector generator 402 generates the n-dimensional vector Va described above. The hash function section 404 calculates a hash value for an input value according to an algorithm of, for example, SHA-1 or SHA-256. The output section 405 outputs a shared key, which will be described later.

The second cryptographic key sharing unit 410 includes an inner product calculating section B 411, a vector generator 412, an inner product calculating section A 413, a hash function section 414, and an output section 415. The inner product calculating section B 411 is equal to the inner product calculating section B 403, the vector generator 412 generates the n-dimensional vector Vb. The inner product calculating section A 413 is equal to the inner product calculating section A 401, and the hash function section 414 is equal to the hash function section 404, and the output section 415 outputs a shared key, which will be described later.

Next, description will be given of operation of the first cryptographic key sharing system 10.

First, the vector generator 402 of the first key sharing unit 400 randomly generates the n-dimensional vector Va and outputs it to the inner product calculating section A 401 and inner product calculating section B 403.

On the other hand, the vector generator 412 of the second key sharing unit 410 randomly generates the n-dimensional vector Vb and outputs it to the inner product calculating section B 411 and inner product calculating section A 413.

The inner product calculating section A 401 of the first key sharing unit 400 communicates with the inner product calculating section B 411 of the second key sharing unit 410, and inner product calculating section A 401 calculates an inner product value C Va*Vb and outputs it to the hash function section 404. Incidentally, it is assumed that the method of calculating the inner product value C is similar to that of the first or second embodying mode. Hence, the first key sharing unit 400 can calculate the inner product value C while the first and second key sharing units 400 and 410 are keeping secret the n-dimensional vectors Va and Vb respectively possessed by themselves.

Similarly, the inner product calculating section A 413 of the second key sharing unit 410 communicates with the inner product calculating section B 403 of the first key sharing unit 400, and inner product calculating section A 413 calculates an inner product value C=Va*Vb and outputs it to the hash function section 414. Incidentally, it is assumed that the inner product calculation method is similar to that of the first or second embodying mode. Therefore, the second key sharing unit 410 can calculate the inner product value C while the first and second key sharing units 400 and 410 are keeping secret the n-dimensional vectors Va and Vb respectively possessed by themselves.

The hash function section 404 of the first key sharing unit 400 calculates a hash value K of the inputted inner product value C, and the output section 405 outputs the hash value K as a shared key. Therefore, it is possible to generate a shared key (cryptographic key) whose security depends neither on the integer factorization problem nor on the discrete logarithm problem.

Similarly, the hash function section 414 of the second key sharing unit 410 calculates a hash value K of the inputted inner product value C, and the output section 415 outputs the hash value K as a shared key. Therefore, the first and second key sharing units 400 and 410 can share the hash key as a shared key.

In the present embodying mode, the calculated hash value K of the inner product value C is employed as the shared key, but it is not limitative; the shared key may be generated in any other method or the inner product value C itself may be used as the shared key.

As above, according to the cryptographic key sharing system 10, the first key sharing unit 400 can calculate the inner product value C while the first and second key sharing units 400 and 410 are keeping secret the n-dimensional vectors Va and Vb respectively possessed by themselves and the second key sharing unit 410 can calculate the inner product value C while the first and second key sharing units 400 and 410 are keeping secret the n-dimensional vectors Va and Vb respectively possessed by themselves; therefore, even if the entire communication between the first key sharing unit 400 and the second key sharing unit 410 is tapped, the n-dimensional vectors Va and Vb are concealed; hence, the listener-in cannot know the inner product value C and the hash value K. Resultantly, the shared key can be safely shared (cannot be calculated by the listener-in). Furthermore, the inner product value C is calculated in the method of the first or second embodying mode, and the inner product value C or the hash value thereof is outputted as the shared key; hence, it is possible to generate the shared key whose security depends neither on the integer factorization problem nor on the discrete logarithm problem. As a result, it is resistive against the quantum computer.

Incidentally, the configuration of the present invention is not restricted by the embodying modes described above, but the embodying modes may be modified in various ways within the gist of the present invention.

The specification and drawings are, accordingly, to be regarded in an illustrative rather than a restrictive sense. It will, however, be evident that various modifications and changes may be made thereto without departing from the spirit and scope of the invention as set forth in the claims.

1. A privacy-preserving scalar product calculation system comprising a first calculation unit for concealing a first n-dimensional vector (n is a positive integer) each element of which is an integer and a second calculation unit for concealing a second n-dimensional vector each element of which is an integer, characterized in that:
the first calculation unit comprises;
a first communication unit capable of communicating information with the second calculation unit,
a first generator for generating first, second, and third random numbers which are integers, and
a converter for linearly transforming, on the basis of an m-by-m nonsingular matrix (m is a positive integer) based on the first random number and on the basis of the second random number, the first n-dimensional vector into an m-by-n matrix, calculating a remainder by dividing each element of the linearly transformed m-by-n matrix by the third random number, and transmitting an m-by-n transformed matrix each element of which is the remainder by the first communication unit;
the second calculation unit comprises;
a second communication unit capable of communicating information with the first calculation unit, and
a calculating section for calculating an m-dimensional vector on the basis of the m-by-n transformed matrix received by the second communication unit and the second n-dimensional vector and transmitting the m-dimensional vector by the second communication unit; and
the first calculation unit further comprises an inverse converter for calculating an m-dimensional vector on the basis of an inverse matrix obtained from the m-by-m nonsingular matrix using the third random number as a modulus and the m-dimensional vector received by the first communication unit, and calculating a remainder by dividing predetermined elements of the m-dimensional vector by the third random number.

2. The privacy-preserving scalar product calculation system according to claim 1, characterized in that:
the first generator generates M as the third random number and W as the first random number;
the converter calculates
(Expression 1)
Xⱼ=WAⱼ mod M
for each element Aⱼ (j=1, 2, . . . , n) of the first n-dimensional vector by using one as the m and transmits an n-dimensional converted vector X=(X₁,X₂, . . . , Xₙ) by the first communication unit;
the calculating section receives the n-dimensional converted vector X by the second communication unit, calculates
(Expression 2)
Z=X₁B₁+X₂B₂+ . . . +XₙBₙ
for each element Bⱼ (j=1, 2, . . . , n) of the first n-dimensional vector, and transmits an inner product Z by the second communication unit; and
the inverse converter calculates
(Expression 3)
C=W⁻¹Z mod M
for the inner product Z received by the first communication unit to thereby calculate C.

3. The privacy-preserving scalar product calculation system according to claim 1, characterized in that:
the first generator generates, for predetermined numbers Q, R, S, and p which are positive integers, Rⱼ (j=1,2, . . . ,n; Rⱼ<R) as the second random number, Mᵢ (i=1,2, . . . ,p; M₁>nRSQ² and Mᵢ>nRSQ²Mᵢ₋₁ (i=2,3, . . . ,p)) as the third random number, and Wᵢ (i=1,2, . . . ,p; Wᵢ<Mᵢ and GCD(Wᵢ,Mᵢ)=1);
the converter calculates
X_{1,j}=RⱼQ+Aⱼ
X_{i+1,j}=WⱼX_{i,j} mod Mᵢ
(repeatedly calculate for i=1, 2, . . . , p)
(Expression 4)
Xⱼ=X_{P+1,j}
for each element Aⱼ (j=1, 2, . . . , n) of the first n-dimensional vector by using one as the m and transmits an n-dimensional converted vector X=(X₁,X₂, . . . , Xₙ) by the first communication unit;
the second calculation unit comprises
a second generator for generating, for the predetermined number S, Sⱼ (j=1, 2, . . . , n; Sⱼ<S) as a fourth random number, and
an expanding section for calculating
(Expression 5)
Yⱼ=SⱼQ+Bⱼ
for each element Bⱼ (j=1,2, . . . ,n) of the second n-dimensional vector to calculate an n-dimensional expanded vector Y=(Y₁,Y₂, . . . , Yₙ);
the calculating section receives the n-dimensional converted vector X by the second communication unit, calculates
(Expression 6)
Z=X₁Y₁+X₂Y₂+ . . . +XₙYₙ
and transmits an inner product Z by the second communication unit; and
the inverse converter calculates
Zₚ₊₁=Z
Zᵢ=Wᵢ⁻¹Zᵢ₊₁ mod Mᵢ
(repeatedly calculate for i=p, p−1, . . . , 1)
(Expression 7)
C=Z₁ mod Q
for the inner product Z received by the first communication unit to thereby calculate C.

4. The privacy-preserving scalar product calculation system according to claim 3, characterized by setting the predetermined number Q to satisfy
(Expression 8)
Q>nN²
for a maximum value N selected from each element Aⱼ (j=1,2, . . . ,n) of the first n-dimensional vector and each element Bⱼ (j=1,2, . . . ,n) of the second n-dimensional vector.

5. The privacy-preserving scalar product calculation system according to claim 1, characterized in that:
the first generator generates R_{2,j} (j=1,2, . . . ,n) as the second random number, M as the third random number, and W₁₁, W₁₂, W₂₁, and W₂₂ (W₁₁W₂₂−W₁₂W₂₁ is not equal to 0) as the first random number;
the converter calculates
$$\begin{matrix}( Expression 9 ) & \\ X = ( \begin{matrix}{X}_{1 , 1} … {X}_{1 , n} \\ {X}_{2 , 1} … {X}_{2 , n}\end{matrix} ) = ( \begin{matrix}{W}_{11} & {W}_{12} \\ {W}_{21} & {W}_{22}\end{matrix} ) ( \begin{matrix}{A}_{1} … {A}_{n} \\ {R}_{2 , 1} … {R}_{2 , n}\end{matrix} ) mod M & \end{matrix}$$
for each element Aⱼ (j=1, 2, . . . , n) of the first n-dimensional vector by using two as the m and transmits a two-by-n transformed matrix X by the first communication unit;
the calculating section calculates
$$\begin{matrix}( Expression 10 ) & \\ ( \begin{matrix}{Z}_{1} \\ {Z}_{2}\end{matrix} ) = ( \begin{matrix}{X}_{1 , 1} … {X}_{1 , n} \\ {X}_{2 , 1} … {X}_{2 , n}\end{matrix} ) ( \begin{matrix}{B}_{1} \\ ⋮ \\ {B}_{n}\end{matrix} ) & \end{matrix}$$
for each element Bⱼ (j=1, 2, . . . , n) of the second n-dimensional vector, and transmits a two-dimensional vector Z=(Z₁,Z₂) by the second communication unit; and
the inverse converter calculates
$$\begin{matrix}( Expression 11 ] & \\ ( \begin{matrix}{C}_{1} \\ {C}_{2}\end{matrix} ) = {( \begin{matrix}{W}_{11} & {W}_{12} \\ {W}_{21} & {W}_{22}\end{matrix} )}^{- 1} ( \begin{matrix}{Z}_{1} \\ {Z}_{2}\end{matrix} ) mod M \\ C = {C}_{1} & \end{matrix}$$
for the two-dimensional vector Z received by the first communication unit to thereby calculate C.

6. The privacy-preserving scalar product calculation system according to claim 1, characterized in that:
the first generator generates, for predetermined numbers Q, R, and S which are positive integers, R_{1,j} (j=1,2, . . . ,n; R_{1,j}<R) and R_{2,j} (j=1,2, . . . ,n; R_{2,j}<M) as the second random number, one M (M>nSRQ²) as the third random number, and W₁₁, W₁₂, W₂₁, and W₂₂ (W₁₁, W₁₂, W₂₁, W₂₂<M and GCD(W₁₁W₂₂−W₁₂W₂₁,M)=1) as the first random number;
the converter calculates
$$\begin{matrix}( Expression 12 ) & \\ {A}_{j}^{′} = {R}_{1 , j} \cdot Q + {A}_{j} ( j = 1 , 2 , … n ) \\ X = ( \begin{matrix}{X}_{1 , 1} … {X}_{1 , n} \\ {X}_{2 , 1} … {X}_{2 , n}\end{matrix} ) = ( \begin{matrix}{W}_{11} & {W}_{12} \\ {W}_{21} & {W}_{22}\end{matrix} ) ( \begin{matrix}{A}_{1}^{′} … {A}_{n}^{′} \\ {R}_{2 , 1} … {R}_{2 , n}\end{matrix} ) mod M & \end{matrix}$$
for each element Aⱼ (j=1, 2, . . . , n) of the first n-dimensional vector by using two as the m and transmits a 2-by-n transformed matrix X by the first communication unit;
the second calculation unit comprises
a second generator for generating, for the predetermined number S, Sⱼ (j=1, 2, . . . , n; Sⱼ<S) as a fourth random number, and
an expanding section for calculating
(Expression 13)
Yⱼ=SⱼQ+Bⱼ
for each element Bⱼ (j=1,2, . . . ,n) of the second n-dimensional vector to calculate an n-dimensional expanded vector Y=(Y₁,Y₂, . . . , Yₙ);
the calculating section calculates
$$\begin{matrix}( Expression 14 ) & \\ ( \begin{matrix}{Z}_{1} \\ {Z}_{2}\end{matrix} ) = ( \begin{matrix}{X}_{1 , 1} … {X}_{1 , n} \\ {X}_{2 , 1} … {X}_{2 , n}\end{matrix} ) ( \begin{matrix}{Y}_{1} \\ ⋮ \\ {Y}_{n}\end{matrix} ) & \end{matrix}$$
and transmits a two-dimensional vector Z=(Z₁, Z₂) by the second communication unit; and
the inverse converter calculates
$$\begin{matrix}( Expression 15 ] & \\ ( \begin{matrix}{C}_{1} \\ {C}_{2}\end{matrix} ) = {( \begin{matrix}{W}_{11} & {W}_{12} \\ {W}_{21} & {W}_{22}\end{matrix} )}^{- 1} ( \begin{matrix}{Z}_{1} \\ {Z}_{2}\end{matrix} ) mod M \\ C = {C}_{1} mod Q & \end{matrix}$$
for the two-dimensional vector Z received by the first communication unit to thereby calculate C.

7. The privacy-preserving scalar product calculation system according to claim 6, characterized by setting the predetermined number Q to satisfy
(Expression 16)
Q>nN²
for a maximum value N selected from each element Aⱼ (j=1,2, . . . ,n) of the first n-dimensional vector and each element Bⱼ (j=1,2, . . . ,n) of the second n-dimensional vector.

8. A privacy-preserving scalar product calculation method for use with a system comprising a first calculation unit for concealing a first n-dimensional vector (n is a positive integer) each element of which is an integer and a second calculation unit for concealing a second n-dimensional vector each element of which is an integer, wherein
the first calculation unit comprises a first communication unit capable of communicating information with the second calculation unit, and the second calculation unit comprises a second communication unit capable of communicating information with the first calculation unit, the method characterized by comprising:
a first generating step of generating first, second, and third random numbers which are integers by the first calculation unit;
a converting step of linearly transforming by the first calculation unit, on the basis of an m-by-m nonsingular matrix (m is a positive integer) based on the first random number and on the basis of the second random number, the first n-dimensional vector into an m-by-n matrix, calculating a remainder by dividing each element of the linearly transformed m-by-n matrix by the third random number, and transmitting an m-by-n transformed matrix each element of which is the remainder by the first communication unit;
a calculating step of calculating by the second calculation unit an m-dimensional vector on the basis of the m-by-n matrix transformed matrix received by the second communication unit and the second n-dimensional vector and transmitting the m-dimensional vector by the second communication unit; and
an inversely converting step of calculating by the first calculation unit an m-dimensional vector on the basis of an inverse matrix obtained from the m-by-m nonsingular matrix using the third random number as a modulus and the m-dimensional vector received by the first communication unit, and calculating a remainder by dividing predetermined elements of the m-dimensional vector by the third random number.

9. The privacy-preserving scalar product calculation method according to claim 8, characterized in that:
the first generating step generates M as the third random number and W as the first random number;
the converting step calculates
(Expression 17)
Xⱼ=WAⱼ mod M
for each element Aⱼ (j=1, 2, . . . , n) of the first n-dimensional vector by using one as the m and transmits an n-dimensional converted vector X=(X₁,X₂, . . . , Xₙ) by the first communication unit;
the calculating step receives the n-dimensional converted vector X by the second communication unit, calculates
(Expression 18)
Z=X₁B₁+X₂B₂+ . . . +XₙBₙ
for each element Bⱼ (j=1, 2, . . . , n) of the first n-dimensional vector, and transmits an inner product Z by the second communication unit; and
the inversely converting step calculates
(Expression 19)
C=W⁻¹Z mod M
for the inner product Z received by the first communication unit to thereby calculate C.

10. The privacy-preserving scalar product calculation method according to claim 8, characterized in that:
the first generating step generates, for predetermined numbers Q, R, S, and p which are positive integers, Rⱼ (j=1,2, . . . ,n; Rⱼ<R) as the second random number, Mᵢ (i=1,2, . . . ,p; M₁>nRSQ² and Mᵢ>nRSQ²Mᵢ₋₁ (i=2,3, . . . ,p)) as the third random number, and Wᵢ (i=1,2, . . . ,p; Wᵢ<Mᵢ and GCD(Wᵢ,Mᵢ)=1); and
the converting step calculates
X_{1,j}=RⱼQ+Aⱼ
X_{i+1,j}=WⱼX_{i,j} mod Mᵢ
(repeatedly calculate for i=1, 2, . . . p)
(Expression 20)
Xⱼ=X_{p+1,j}
for each element Aⱼ (j=1, 2, . . . , n) of the first n-dimensional vector by using one as the m and transmits an n-dimensional converted vector X=(X₁,X₂, . . . , Xₙ) by the first communication unit, the method further comprising:
a second generating step of generating by the second calculation unit, for the predetermined number S, Sⱼ (j=1, 2, . . . , n; Sⱼ<S) as a fourth random number; and
an expanding step of calculating
(Expression 21)
Yⱼ=SⱼQ+Bⱼ
for each element Bⱼ (j=1,2, . . . ,n) of the second n-dimensional vector to calculate an n-dimensional expanded vector Y=(Y₁,Y₂, . . . ,Yₙ), and
the calculating step receives the n-dimensional converted vector X by the second communication unit, calculates
(Expression 22)
Z=X₁Y₁+X₂Y₂+ . . . +XₙYₙ
and transmits an inner product Z by the second communication unit; and
the inversely converting step calculates
Zₚ₊₁=Z
Zᵢ=Wᵢ⁻¹Zᵢ₊₁ mod Mᵢ
(repeatedly calculate for i=p, P−1, . . . , 1)
(Expression 23)
C=Z₁ mod Q
for the inner product Z received by the first communication unit to thereby calculate C.

11. The privacy-preserving scalar product calculation method according to claim 10, characterized by further comprising a step of setting the predetermined number Q to satisfy
(Expression 24)
Q>nN²
for a maximum value N selected from each element Aⱼ (j=1,2, . . . ,n) of the first n-dimensional vector and each element Bⱼ (j=1,2, . . . ,n) of the second n-dimensional vector.

12. The privacy-preserving scalar product calculation method according to claim 8, characterized in that:
the first generating step generates R_{2,j} (j=1,2, . . . ,n) as the second random number, M as the third random number, and W₁₁, W₁₂, W₂₁, and W₂₂ (W₁₁W₂₂−W₁₂W₂₁ is not equal to 0) as the first random number;
the converting step calculates
$$\begin{matrix}( Expression 25 ] & \\ ( \begin{matrix}{X}_{1 , 1} … {X}_{1 , n} \\ {X}_{2 , 1} … {X}_{2 , n}\end{matrix} ) = ( \begin{matrix}{W}_{11} & {W}_{12} \\ {W}_{21} & {W}_{22}\end{matrix} ) ( \begin{matrix}{A}_{1} … {A}_{n} \\ {R}_{2 , 1} … {R}_{2 , n}\end{matrix} ) mod M & \end{matrix}$$
for each element Aⱼ (j=1, 2, . . . , n) of the first n-dimensional vector by using two as the m and transmits a two-by-n transformed matrix X by the first communication unit;
the calculating step calculates
$$\begin{matrix}( Expression 26 ) & \\ ( \begin{matrix}{Z}_{1} \\ {Z}_{2}\end{matrix} ) = ( \begin{matrix}{X}_{1 , 1 } … {X}_{1 , n} \\ {X}_{2 , 1} … {X}_{2 , n}\end{matrix} ) ( \begin{matrix}{B}_{1} \\ ⋮ \\ {B}_{n}\end{matrix} ) & \end{matrix}$$
for the second n-dimensional vector B=(B₁,B₂, . . . ,Bₙ) and transmits a two-dimensional vector Z=(Z₁,Z₂) by the second communication unit; and
the inversely converting step calculates
$$\begin{matrix}( Expression 27 ) & \\ ( \begin{matrix}{C}_{1} \\ {C}_{2}\end{matrix} ) = {( \begin{matrix}{W}_{11} & {W}_{12} \\ {W}_{21} & {W}_{22}\end{matrix} )}^{- 1} ( \begin{matrix}{Z}_{1} \\ {Z}_{2}\end{matrix} ) mod M \\ C = {C}_{1} & \end{matrix}$$
for the two-dimensional vector Z received by the first communication unit to thereby calculate C.

13. The privacy-preserving scalar product calculation method according to claim 8, characterized in that:
the first generating step generates, for predetermined numbers Q, R, and S which are positive integers, R_{1,j} (j=1,2, . . . ,n; R_{1,j}<R) and R_{2,j} (j=1,2, . . . ,n; R_{2,j}<M) as the second random number, one M (M>nRSQ²) as the third random number, and W₁₁, W₁₂, W₂₁, and W₂₂ (W₁₁, W₁₂, W₂₁, W₂₂<M and GCD(W₁₁W₂₂−W₁₂W₂₁,M)=1) as the first random number; and
the converting step calculates
$$\begin{matrix}( Expression 28 ) & \\ {A}_{j}^{′} = {R}_{1 , j} \cdot Q + {A}_{j} ( j = 1 , 2 , … n ) \\ X = ( \begin{matrix}{X}_{1 , 1} … {X}_{1 , n} \\ {X}_{2 , 1} … {X}_{2 , n}\end{matrix} ) = ( \begin{matrix}{W}_{11} & {W}_{12} \\ {W}_{21} & {W}_{22}\end{matrix} ) ( \begin{matrix}{A}_{1}^{′} … {A}_{n}^{′} \\ {R}_{2 , 1} … {R}_{2 , n}\end{matrix} ) mod M & \end{matrix}$$
for each element Aⱼ (j=1, 2, . . . , n) of the first n-dimensional vector by using two as the m and transmits a 2-by-n transformed matrix X by the first communication unit, the method further comprising:
a second generating step of generating by the second calculation unit, for the predetermined number S, Sⱼ (j=1, 2, . . . , n; Sⱼ<S) as a fourth random number; and
an expanding step of calculating by the second calculation unit
(Expression 29)
Yⱼ=SⱼQ+Bⱼ
for each element Bⱼ (j=1,2, . . . ,n) of the second n-dimensional vector to calculate an n-dimensional expanded vector Y=(Y₁,Y₂, . . . ,Yₙ), and
the calculating step calculates
$$\begin{matrix}( Expression 30 ) & \\ ( \begin{matrix}{Z}_{1} \\ {Z}_{2}\end{matrix} ) = ( \begin{matrix}{X}_{1 , 1} … {X}_{1 , n} \\ {X}_{2 , 1} … {X}_{2 , n}\end{matrix} ) ( \begin{matrix}{Y}_{1} \\ ⋮ \\ {Y}_{n}\end{matrix} ) & \end{matrix}$$
and transmits a two-dimensional vector Z=(Z₁, Z₂) by the second communication unit; and
the inversely converting step calculates
$$\begin{matrix}( Expression 31 ) & \\ ( \begin{matrix}{C}_{1} \\ {C}_{2}\end{matrix} ) = {( \begin{matrix}{W}_{11} & {W}_{12} \\ {W}_{21} & {W}_{22}\end{matrix} )}^{- 1} ( \begin{matrix}{Z}_{1} \\ {Z}_{2}\end{matrix} ) mod M \\ C = {C}_{1} mod Q & \end{matrix}$$
for the two-dimensional vector Z received by the first communication unit to thereby calculate C.

14. The privacy-preserving scalar product calculation method according to claim 13, characterized by further comprising a step of setting the predetermined number Q to satisfy
(Expression 32)
Q>nN²
for a maximum value N selected from each element Aⱼ (j=1,2, . . . ,n) of the first n-dimensional vector and each element Bⱼ (j=1,2, . . . ,n) of the second n-dimensional vector.

15. A cryptographic key sharing system comprising a first key sharing unit for concealing a first n-dimensional vector (n is a positive integer) each element of which is an integer and a second key sharing unit for concealing a second n-dimensional vector each element of which is an integer, characterized in that:
the first key sharing unit comprises;
a first inner product calculating section for calculating a first inner product value between the first n-dimensional vector and the second n-dimensional vector by use of the privacy-preserving scalar product calculation method according to claim 8, and
a first cipher key generator for generating a first cipher key on the basis of the first inner product value calculated by the first inner product calculating section; and
the second key sharing unit comprises;
a second inner product calculating section for calculating a second inner product value between the first n-dimensional vector and the second n-dimensional vector by use of the privacy-preserving scalar product calculation method according to claim 8, and
a second cipher key generator for generating a second cipher key on the basis of the second inner product value calculated by the second inner product calculating section.

16. The cryptographic key sharing system according to claim 15, characterized in that:
the first cipher key generator calculates a hash value of the first inner product value by use of a predetermined hash function and sets the hash value as the first cipher key; and
the second cipher key generator calculates a hash value of the second inner product value by use of the predetermined hash function and sets the hash value as the second cipher key.
